(19) United States
(12) Patent Application Publication
(10) Pub. No.: US 2012/0039480 A1
(43) Pub. Date: Feb. 16, 2012

(54) METHOD AND APPARATUS FOR IMPROVED DIRECTIVITY OF AN ACOUSTIC ANTENNA

(75) Inventor: Stefan Willems, Dendermonde (BE)

(73) Assignee: PSS Belgium N.V., Dendermonde (BE)

(21) Appl. No.: 13/131,503

(22) PCT Filed: Nov. 17, 2009
(86) PCT No.: PCT/IB2009/007555

§ 371 Date: Sep. 15, 2011

(30) Foreign Application Priority Data
Dec. 2, 2008 (GB) 0821999.0

(51) Int. Cl. G10K 11/16

(52) U.S. Cl. 381/71.1

(57) ABSTRACT

The present invention provides a method of controlling an acoustic transducer array to generate a directional sound profile, the method including the steps of:
(i) controlling the transducer array to generate, on the basis of a first signal, a primary sound profile which, when represented in polar coordinates, has a primary lobe extending along a first axis and an auxiliary lobe, associated with the primary lobe, extending along a second axis which is respectively different to the first axis; and
(ii) generating, on the basis of the first signal, a cancelling signal for controlling the transducer array to generate a cancelling sound profile which, when represented in polar coordinates, has a cancelling lobe extending along said second axis, which cancelling lobe is modified in phase to interfere destructively with said auxiliary lobe.

The present invention relates to improvements in the perceived directivity of an acoustic antenna, in particular, but not exclusively, to improvements in the directivity of an acoustic antenna as perceived by a user wishing to listen to the main output of such an antenna by reflection e.g. from a wall.

It is well known that an acoustic transducer with a given directivity can be produced using an acoustic antenna e.g. in the form of an acoustic array, such as a phased loudspeaker array.

A phased loudspeaker array can be thought of as a (linear) array using N driver units that are each fed each with a proprietary signal.

For example, a fundamental approach to array processing for generating a directional sound profile is known as ‘delay-and-sum beamforming’. In this approach, a specific target direction is chosen in which it is desired to have maximum output. This can be achieved by adding an individual delay to each loudspeaker signal, such that in the target direction they compensate the phase differences between the sound fields emitted by the individual loudspeakers.

The delay values that are needed for this can be determined geometrically from the relative positions of the loudspeakers and the target direction, or position.

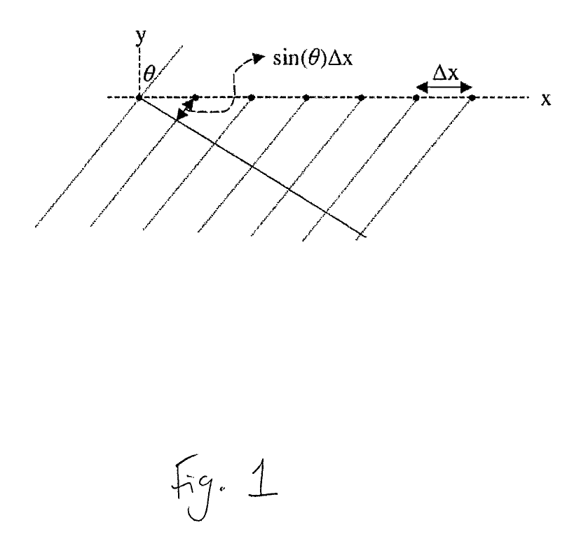

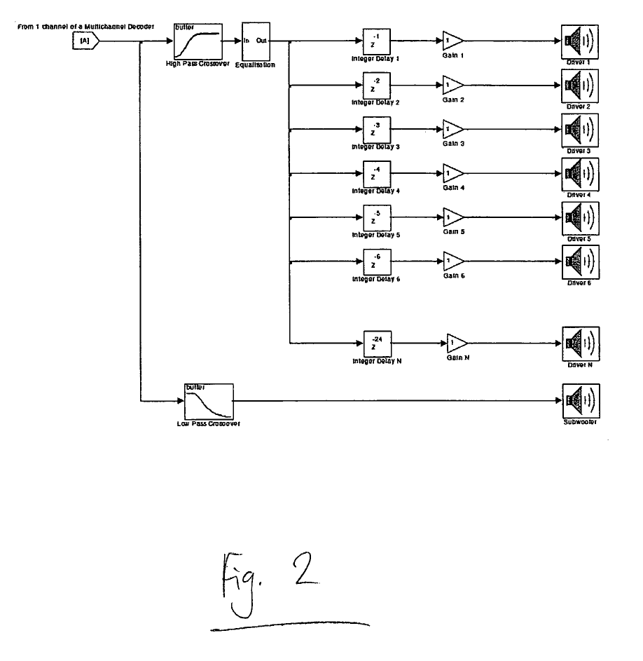

FIG. 1 shows the geometry for a linear array along the x-axis with constant spacing Δx and a target direction having an angle θ relative to the array normal.

It can be seen from FIG. 1 that the required delay for loudspeaker n (with n=0 for the loudspeaker at the origin and increasing in the positive x-direction) is given by:

tₙ=nΔx sin(θ) (1)

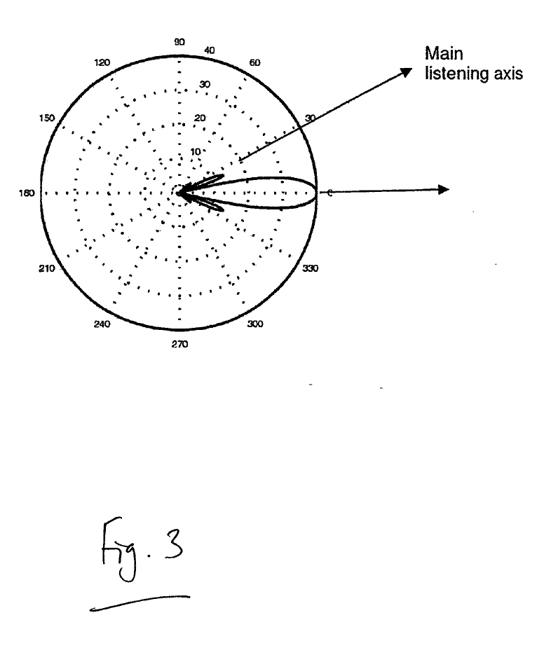

FIG. 2 shows in detail how an acoustic beam can be generated in one particular direction by an array of N loudspeakers Driver1, . . . , DriverN.

First, the input signal is replicated N times. Then, each of the N replicas is delayed by an individual delay Integer Delay1 . . . N, the value of which is determined by the position of the corresponding loudspeaker DriverN and the direction to which the beam is to be steered, according to equation (1) above. Finally, the N delayed signals are fed to their corresponding loudspeakers and an acoustic beam is generated in the desired direction (the gains Gain1, . . . , GainN are optional and can be used for amplitude tapering.

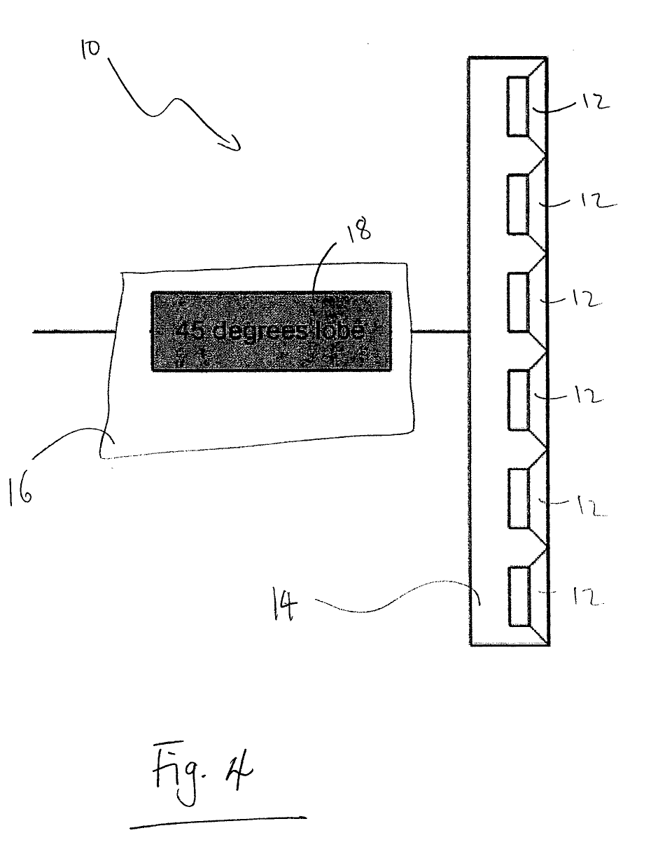

FIG. 3 shows a typical polar plot of the output of a phased loudspeaker array at a particular frequency. The plot shows a large amplitude main lobe (beam) and side lobes of lesser amplitude.

In some applications of loudspeaker arrays, the main listening axis is preferentially not the axis along which the main lobe extends. For example in some applications, the main lobe is intended to be heard by reflection, e.g. from a wall or other surface. This should lead the user to perceive that the sound wave originates from a source other than the loudspeaker array, e.g. behind them and/or to one side. This has beneficial effects for the user's enjoyment of e.g. films and video games.

However, the user may be located at a position which falls on or close to the axis along which one of the side lobes is directly projected.

In such an arrangement, the user's perception of the generated sound will be impaired because not only will he perceive the reflected main lobe by reflection but he will also perceive the undesirable side lobe directly from the loudspeaker array. This can have a detrimental effect on the quality of the sound as perceived by the user and/or on the user's perception of the location of the origin of the sound.

By applying a tapering methodology to the transducer array, the side lobes can be reduced in amplitude, thereby alleviating some of the detriment as perceived by the user. See, Van der Werff “Arrays without side lobes”, Convention paper 5322, Audio Engineering Society. However, such a methodology suffers from drawbacks. For example, the main lobe is often broadened and thus loses a degree of directivity, which is undesirable.

An alternative method, which is allegedly capable of eliminating the side lobes completely is described in “Electronically Controlled Loudspeaker Arrays without Side Lobes”, Convention paper 5322, Audio Engineering Soc., Van der Werff, presented at the 110^{th} Convention 2001 May 12-15. However, this method also suffers from drawbacks, namely that each loudspeaker element in the loudspeaker array is fed by a digital filter, making the data processing very complex and thus potentially slow and limiting. For example, in the case of e.g. a 16 element array intended to reproduce a multichannel audio system (5 channels to be reproduced), this would require 80 filters, and each filter consists of 512 taps FIR filters. Consequently, the overall digital signal processing (DSP) requirement is large.

Accordingly, in general, the present invention aims to reduce a users perception of side lobes, without significantly adversely affecting the main lobe and without the need for significant DSP requirements.

Therefore, the present invention provides a method of controlling a transducer array to generate an (improved) directional sound profile as set forth in claim 1.

Advantageously, according to the present invention, the amplitude of the auxiliary lobe is reduced, thereby reducing the user's perception of the auxiliary lobe and thus improving the user's perception of the quality of the primary sound profile and of the location of the origin of the primary sound profile.

The cancelling sound profile may have a cancelling lobe (and possibly a plurality of associated auxiliary lobes), such that the cancelling sound profile substantially matches the profile of the primary sound profile of the transducer array, albeit possibly with a different amplitude and directivity. Indeed, the array is preferably controlled to generate the cancelling sound profile on the basis of the first signal.

Preferably, a filter means is provided to generate the cancelling signal on the basis of the first signal, the filter means having a frequency response similar to a known frequency characteristic of a side lobe of a primary sound profile generated by the transducer array in response to a primary signal, which primary signal is generated by a transducer controller on the basis of the first signal, the known frequency characteristic being taken to correspond to the frequency characteristic of the side lobe at the intended position of the user.

The filter means may generate the cancelling signal on the basis of the first signal, for example. The filter means may be configured to produce a cancelling signal for controlling the transducer to generate a cancelling sound profile having a main lobe with a frequency characteristic matching that of a known frequency characteristic of a side lobe of a primary sound profile generated by the transducer array in response to a primary signal, generated by a transducer controller on the basis of the first signal, the known frequency characteristic being taken to correspond to the frequency characteristic of the side lobe at the intended position of the user.

By effecting modification of the phase of the cancelling lobe of the cancelling sound profile, the undesirable auxiliary lobe of the primary sound profile and the cancelling lobe of the cancelling sound profile can be caused to destructively interfere with one another, preferably to substantially cancel each other out.

Therefore, it is desirable for the cancelling lobe of the cancelling beam to exhibit similar, or more preferably identical, frequency dependent characteristics to the (undesirable) auxiliary lobe which is to be cancelled out. A skilled person is capable of providing a suitable means, e.g. a filter means, to produce this effect.

A beam canceller according to the present invention is suitable for modifying the output of an acoustic transducer array controllable by a controller to generate a primary sound profile which, when represented in polar coordinates, has a primary lobe extending along a first axis and an auxiliary lobe, associated with the primary lobe, extending along a second axis which is respectively different to the first axis, the controller being configured to control the transducer array on the basis of a received first signal; wherein the beam canceller is configured to provide to the transducer array a cancelling signal, derived from the first signal, suitable for controlling the transducer array to generate a cancelling sound profile which, when represented in polar coordinates, has a cancelling lobe extending along said second axis, but which is modified in phase to interfere destructively with said auxiliary lobe.

The beam canceller may be a filter, where the filter gives rise to the cancelling sound profile from the array, the cancelling sound profile having a cancelling lobe which exhibits frequency dependent characteristics similar to the frequency dependent characteristics of the auxiliary lobe of the primary sound profile.

In another aspect, the present invention provides an apparatus, e.g. capable of outputting an acoustic sound profile, as set for the in claim 15. The apparatus may be an audio hi-fi apparatus. The apparatus may be a surround sound apparatus, e.g. for use with a screen such as a television screen and/or a cinema screen.

In any aspect, the array of acoustic transducers may be provided as an array of discrete transducers, but alternatively, two or more of the plurality of acoustic transducers may be provided in a single unit.

The present invention will now be described by way of example, in which:

FIG. 1 shows a representation useful in understanding the conventional sum and delay technique;

FIG. 2 shows an example of an implementation of the conventional sum and delay technique;

FIG. 3 shows a typical polar plot representative of the directional output of a loudspeaker array e.g. operated using the conventional sum and delay technique;

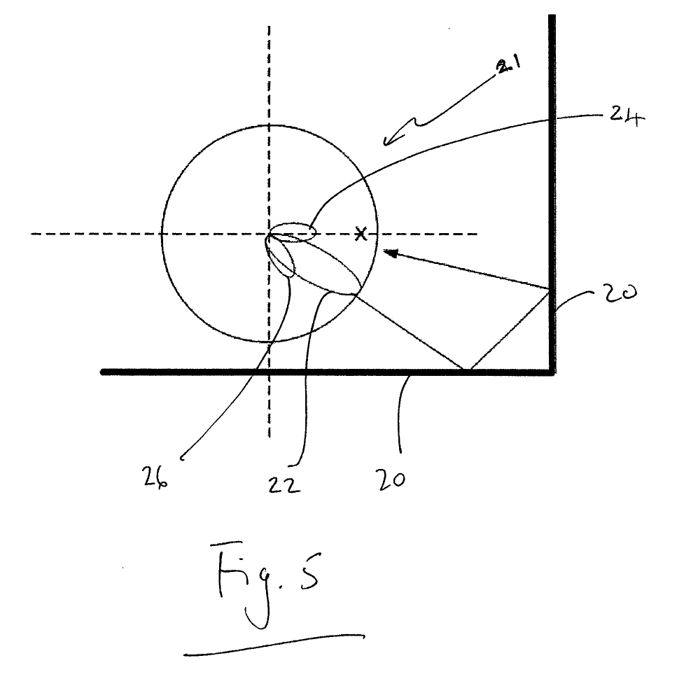

FIG. 4 shows a schematic of a phased array loudspeaker system to which the present invention is applicable;

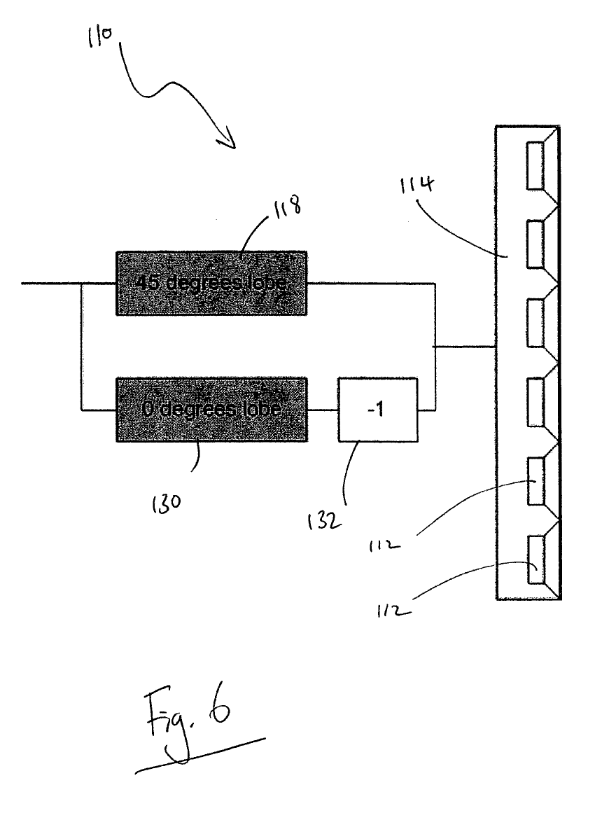

FIG. 5 shows a typical output of the system of FIG. 5, represented on a polar plot, and at a given frequency;

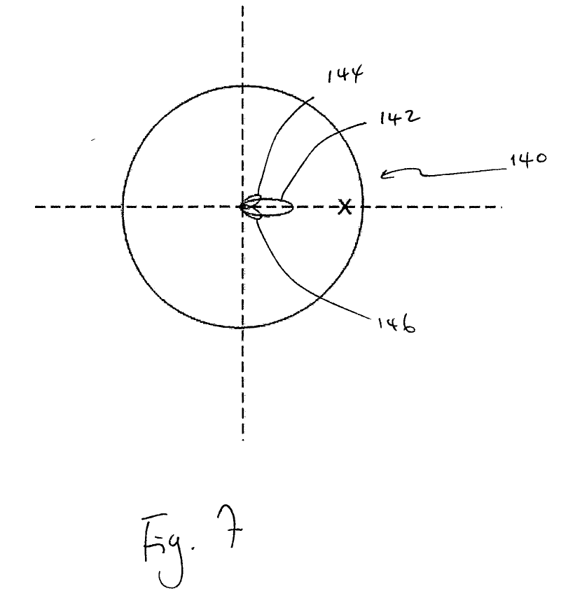

FIG. 6 shows a schematic of an apparatus according to the present invention;

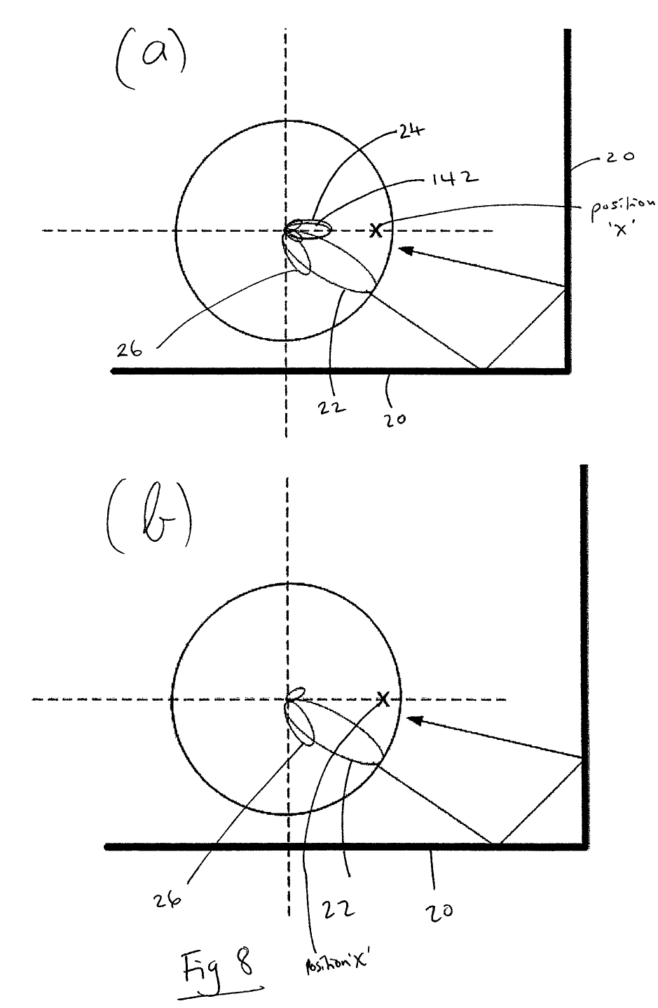

FIG. 7 shows a typical cancelling output which can be produced in accordance with the present invention;

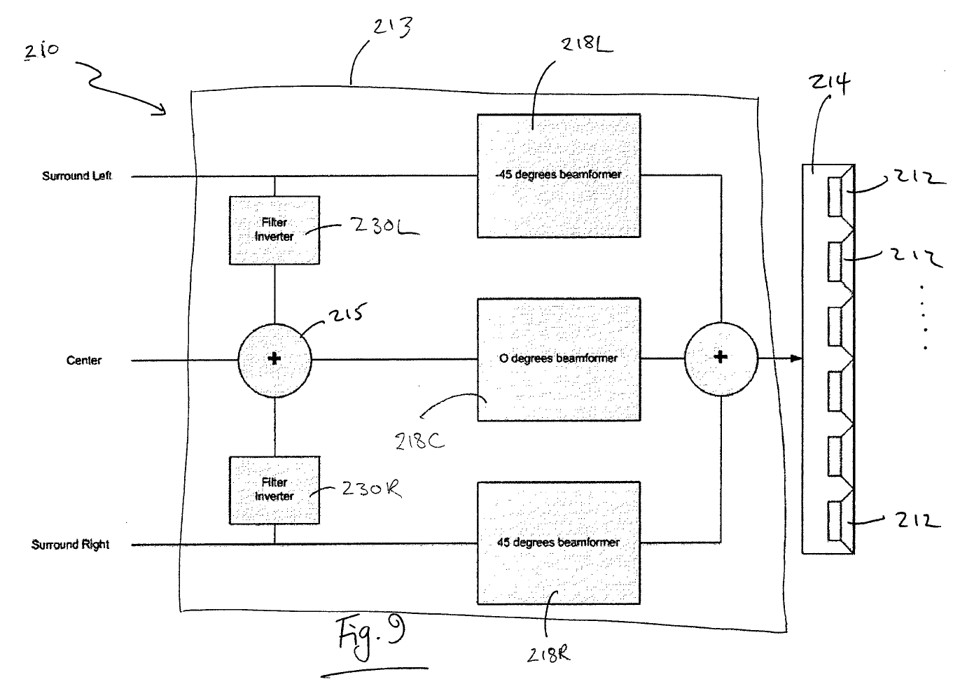

FIG. 8(a) shows a representation, to aid understanding, on a polar plot and at a given frequency of the superposition of a cancelling beam, produced in accordance with the present invention, and a conventional beam;

FIG. 8(b) shows a representation on a polar plot and at a given frequency of the result of the superposition shown in FIG. 8(a);

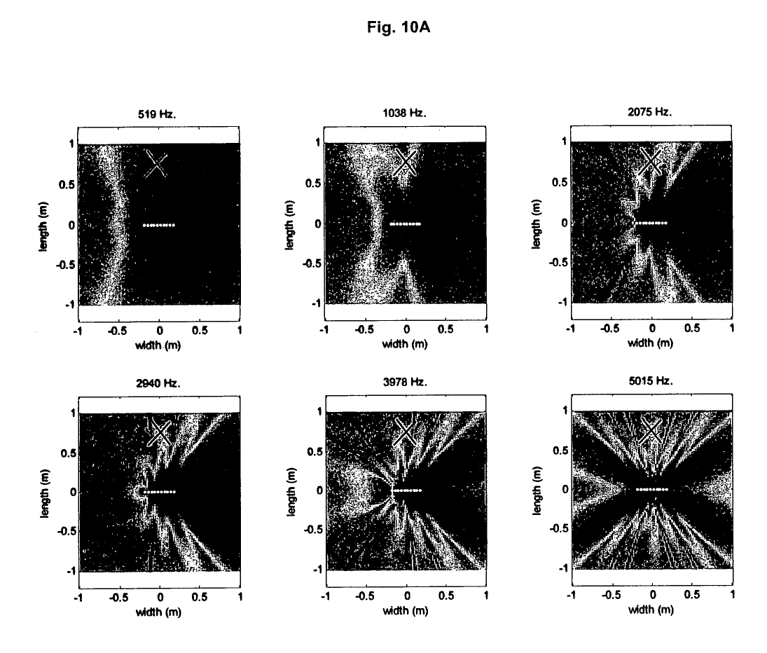

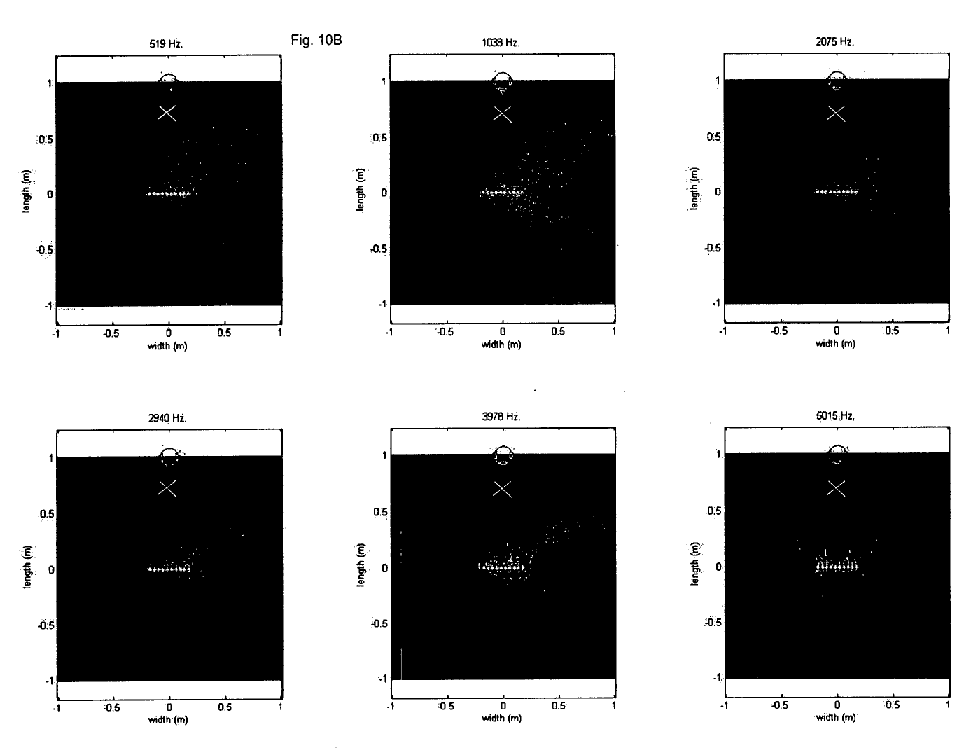

FIG. 9 shows an embodiment of the present invention;

FIG. 10A provides examples of the output of a conventional directional acoustic apparatus at various frequencies in colour;

FIG. 10B provides examples of the output of a conventional directional acoustic apparatus at various frequencies in gray scale;

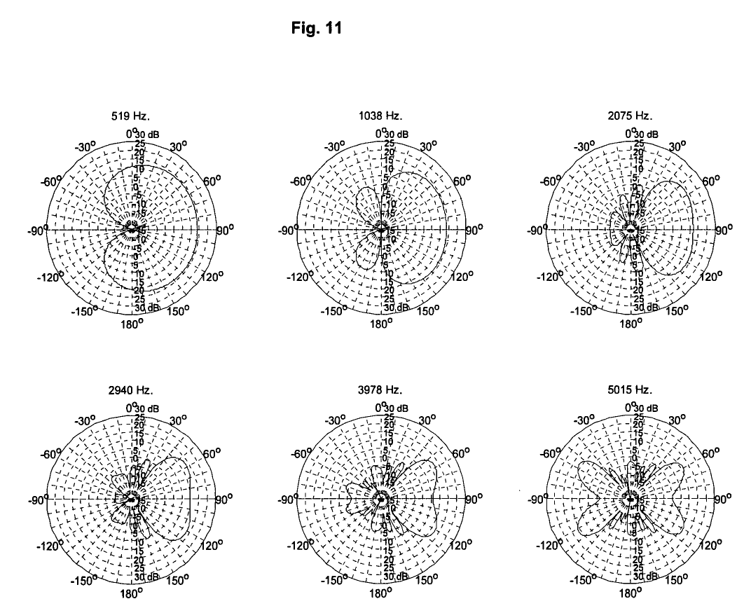

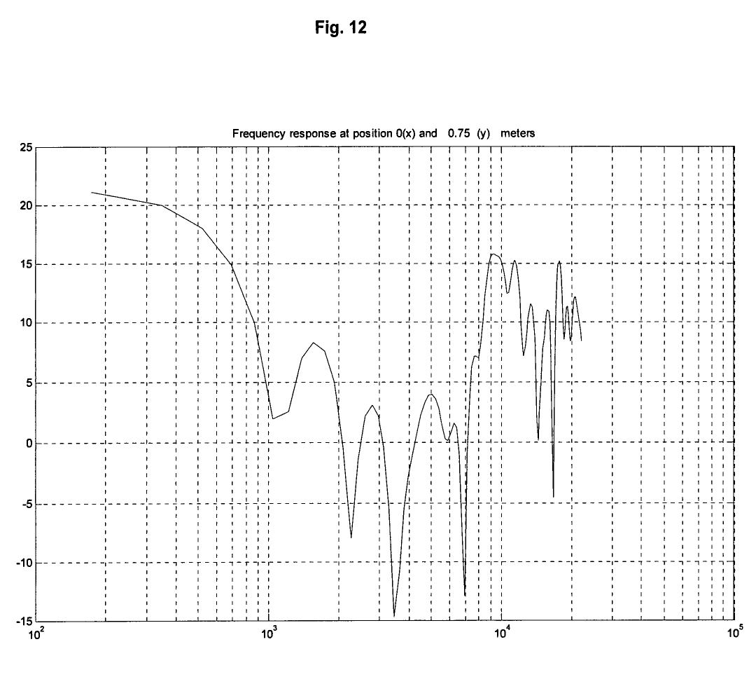

FIG. 11 provides similar information in polar coordinates for the same various frequencies;

FIG. 12 shows the desired frequency dependent characteristics of an embodiment of the present invention based on the information provided in FIGS. 10A, 10B and 11;

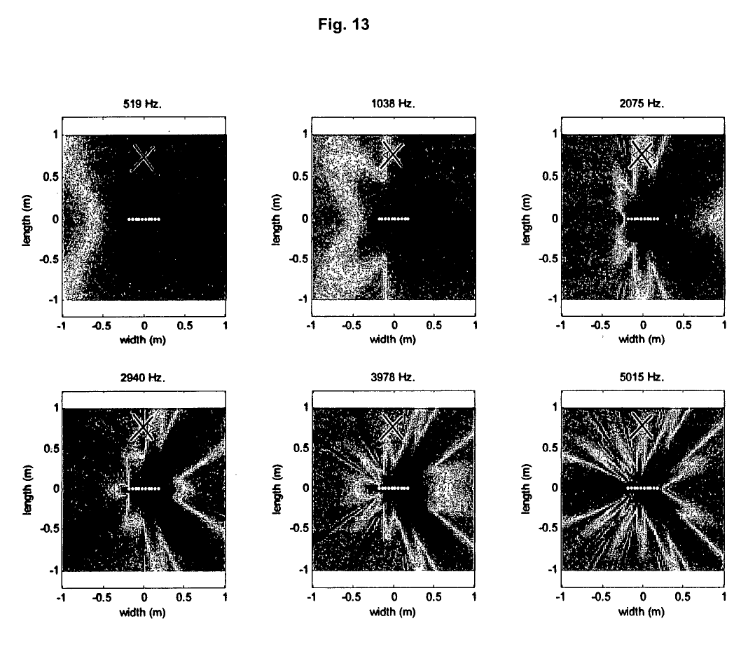

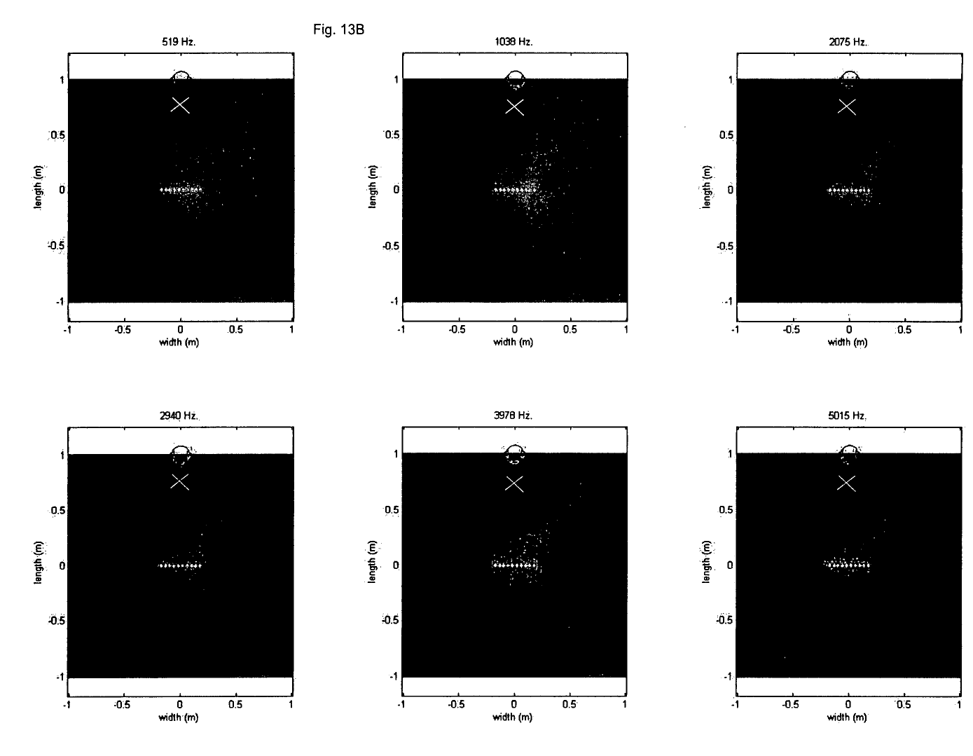

FIG. 13A provides examples of the output of a conventional directional acoustic apparatus at various frequencies in colour;

FIG. 13B provides examples of the output of a conventional directional acoustic apparatus at various frequencies in gray scale;

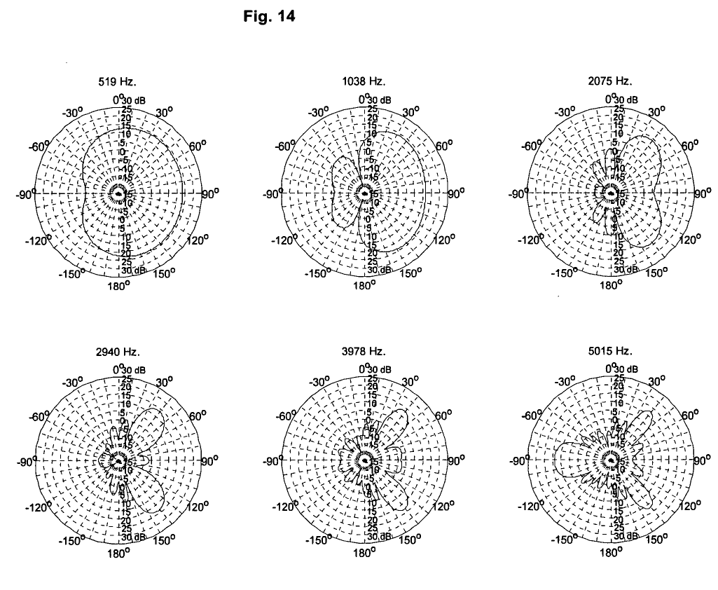

FIG. 14 provides similar information in polar coordinates for the same various frequencies;

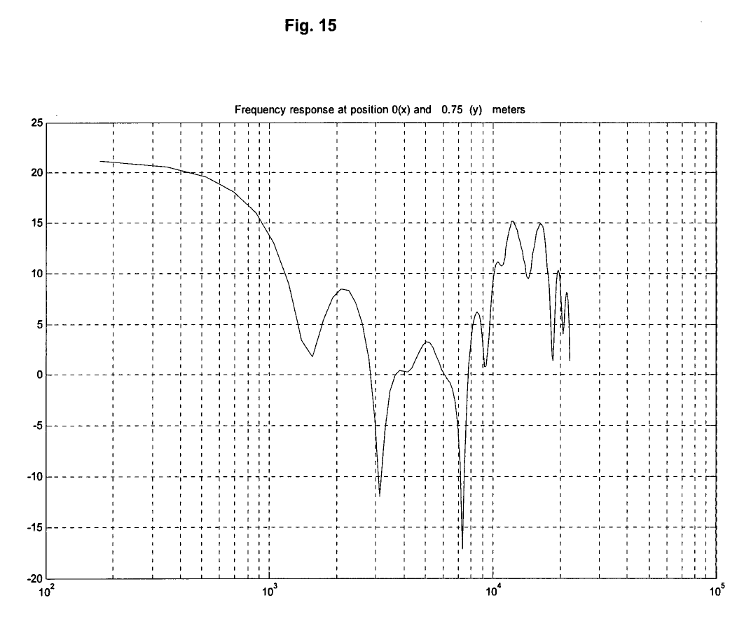

FIG. 15 shows the desired frequency dependent characteristics of an embodiment of the present invention based on the information provided in FIGS. 13A, 13B and 14;

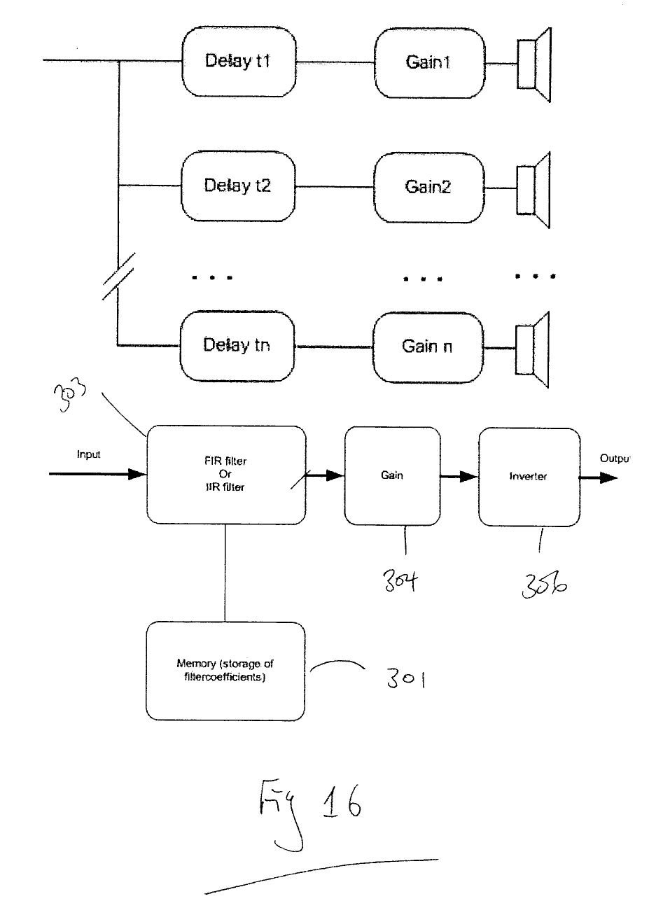

FIG. 16 shows an implementation of the present invention using DSP.

FIG. 4 shows a simplified phased array loudspeaker system 10 with which the present invention is usable. The system 10 includes a plurality of loudspeaker elements 12, arranged in an array 14 to produce a directional sound wave.

The directivity of the output of the array 14 is controlled by directional means 18. The directional means is preferably included in a controller 16 for controlling the output sound overall, e.g. the amplitude etc.

The means 18 may be configured, for example, to control the array 14 to output sound principally along a direction which is 45° to the array normal. The directional means 18 may be configured to operate in accordance with the sum and delay technique in order to give directivity to the output sound.

For example, FIG. 5 shows a representative polar plot of a main output 21 generatable by such a system 10.

The system 10 may be arranged such that the main beam (lobe) 22 of the output sound is intended to be heard by a user at position X, e.g. located on the normal to the array 14, by reflection from one or more surfaces 20, e.g. walls. Due to the path length of the main beam, it may be attenuated before it reaches the ears of the user. Additionally, the reflecting surfaces 20, e.g. the walls, will attenuate the main beam to a greater or lesser degree depending on the precise characteristics of the surfaces 20. In some cases, the attenuation may be significant.

The origin of the polar plot can be considered to be for example any one of the loudspeaker elements 12, e.g. the middle element 12, or an element 12 located at one end of the array 14.

This may be desirable, for example, where the user is intended to perceive that the output sound is generated by a source located behind them (i.e. assuming the user is facing the origin of the polar plot when located at position X). Such an effect may enhance the user's experience of a film or a video game, for example.

However, a characteristic of the system 10 is that side lobes 24 and 26 are also generated. When the system 10 is configured such that the user perceives the main beam 22 by reflection, it is possible that a side lobe 24 is output directly at or very close to the user at position X. The user therefore undesirably experiences the side lobe 24 which interferes with the user's perception of the reflected main beam 20.

In the cases described above where the main beam is attenuated by the path length of the main beam 22 and/or by the characteristics of the surfaces 20, the residual sound pressure level (associated with the main beam) at the user's ear at position X might be equivalent to the sound pressure at the user's ear at position X.

Accordingly, the present invention provides a modified version of the system 10, in the form of system 100, as shown in FIG. 6. The system 110 includes a plurality of loudspeaker elements 112 forming an array 114. The array 114 is preferably controlled on the basis of a directional means 118 and a cancelling means 130. The directional means 118 and the cancelling means 130 may be provided in respective controllers 116 or in a common controller 116 (not shown).

The directional means 118 operates substantially as the directional means 18 described above.

The output of the array 114 is further controlled by the cancelling means 130 to generate a cancelling sound output 140, which in the present embodiment preferably resembles the polar representation shown in FIG. 7. The cancelling sound output profile, represented on a polar plot, will generally include a main beam (lobe) 142 and side lobes 144 and 146.

In FIG. 7, position X is the same as position X shown in FIG. 5. Likewise, the origin of the polar representation shown in FIG. 7 is the same as that shown in FIG. 5.

The system 110 further includes an inverter means 132, for inverting the cancelling sound output 140 with respect to the main output 21. The inverter means 132 may be incorporated in the cancelling means 130. The inverter means 132 may be incorporated in the controller incorporating the cancelling means 130, but e.g. not in the cancelling means 130.

With reference to FIG. 8 (a), it can be seen that the directional means 118 and the cancelling means 130 each effectively cause the array 114 to generate a respective output, which superimpose on one another, such that the main cancelling beam (lobe) 142 being superimposed on the main output side lobe 24. The inclusion of the inverter means 132 results in the superimposed lobes acting to cancel each other out.

FIG. 8 (b) shows the resulting output of the system 100, where the side lobe 24 is effectively cancelled, whereas the main beam 22 is substantially unaffected by the cancellation.

Accordingly, the user at position X will perceive the main beam 22 by reflection from surface 20, and there is no lobe or beam incident directly on him to detrimentally affect his perception of the reflected main beam,

Depending on the characteristics of the array 114, and on the directional means 118, the size of the outputted side lobe 24 can be determined by a skilled person for any given signal input to the system 10.

Therefore, a skilled person will have no difficulty in providing a cancelling means 130 and inverter 132 which effectively mimics the characteristics of the system 10 resulting in the side lobe 24, thereby producing a cancelling output from the array 114 (similar to array 14) having a main (cancelling) beam 142 with substantially the same characteristics, e.g. amplitude, frequency response, etc., as the side lobe 24 so as effectively to match it and substantially to cancel it.

An example of a sound system according to the present invention is shown in FIG. 9, which shows a system 210 which includes a speaker array 214 of speaker elements 212, controllable by an apparatus 213 according to the present invention.

The apparatus 213 is configured to receive a surround left channel, a centre channel and a surround right channel.

The surround left channel is fed to a directional means 218L for controlling the array to generate an output with a mean beam (lobe) at a (e.g. left-hand) angle to the main direction of output of the array 214, e.g. the normal to the array 214. The angle may be 45°. The angle may be another angle between 0° and 90°, preferably non-inclusive.

The surround right channel is fed to a directional means 218R for controlling the array to generate an output with a mean beam (lobe) at a (e.g. right-hand) angle to the main direction of output of the array 214, e.g. the normal to the array 214. The angle may be 45°. The angle may be another angle between 0° and 90°, preferably non-inclusive.

The centre channel is fed to a directional means 218C for controlling the array to generate an output with a mean beam (lobe) substantially along the main direction of output of the array 214, e.g. the normal to the array 214. Directional means 218C may be a 0° beamformer for projecting the centre channel signal.

As described above, each of the directional means 218R and 218L (at least) end up generating side lobes in the output sound wave. The amplitude of those sidelobes varies with frequency.

The apparatus 213 further includes cancelling inverters 230L and 230R. The cancelling inverters 230L, 230R can be thought of as filters which act to mimic the frequency response of the sidelobes described above, but the filter response is in an anti-phase relationship relative to the frequency response of the side lobes themselves—in other words the filter response is inverted relative to the side lobes.

Each signal processed by the cancelling inverter 230L and/or the cancelling inverter 230R is then scaled and mixed with the centre channel signal at means 215 in accordance with the skilled person's common general knowledge, for example.

Thus, the signal(s) generated by each or either of the cancelling inverters 230L, 230R acts to cause a side lobe(s) associated with each of the surround left and right channels to be cancelled out.

The present invention lies in the provision of one or more of the cancelling inverts 230L, 230R, e.g. the cancelling means 130 and inverting means 132, and it is not necessary to include the speaker array in an embodiment according to the invention. It is sufficient for a skilled person to know about the frequency response of an array to which the present invention is to be applied, for example.

Indeed, FIG. 16 shows an example of how the present invention can be implemented using less complex digital signal processing (DSP). In FIG. 16, the delays t1-tn can be implemented by DSP based on filter coefficients e.g. stored in a memory 301, which are referred to by the filter 303. The filter coefficients can be modified to account for the characteristics of any given array, and the preferred effect of the filter 302. The necessary gain can then be applied by the gain means 304, to provide the preferred gain corresponding to the respective channel gains gain(1)−gain(n). As shown in FIG. 9, an inverter 306 may be required to invert a given channel.

### EXAMPLE 1

In an example of a way in which the required frequency dependent characteristics of the cancelling means (cancelling inverter) can be determined, if there is provided a system 10 having ten loudspeaker elements 12, where the main beam 22 (lobe) is directed at 60° to the main axis of the array 14 (e.g. to the normal of the array 14), the frequency response in terms of amplitude against spatial distribution can be represented as shown in FIGS. 10A and 10B for frequencies 0.519 kHz, 1.038 kHz, 2.075 kHz, 2.940 kHz, 3.978 kHz and 5.015 kHz. Position X marks the intended location of a user.

FIG. 11 shows a set of polar representations of the information shown in FIGS. 10A and 10B for particular amplitude at the various selected frequencies. Point X lies along the 0° axis.

FIG. 12 shows the frequency response of the example system at position X. Accordingly, this is the preferred frequency response of a cancelling means should exhibit in an apparatus or system according to the present invention if a user at position X is not to perceive the side lobe(s) output by the array.

### EXAMPLE 2

In another example there is provided a system 10 having ten loudspeaker elements 12, but the main beam 22 (lobe) is directed at 40° to the main axis of the array 14 (e.g. to the normal of the array 14). The frequency response in terms of amplitude against spatial distribution can be represented as shown in FIGS. 13A and 13B for frequencies 0.519 kHz, 1.038 kHz, 2.075 kHz, 2.940 kHz, 3.978 kHz and 5.015 kHz. Position X marks the intended location of a user.

FIG. 14 shows a set of polar representations of the information shown in FIGS. 10A and 10B for a particular amplitude at the various selected frequencies. Point X lies along the 0° axis.

FIG. 15 shows the frequency response of the example system at position X. Accordingly, this is the preferred frequency response of a cancelling means should exhibit in an apparatus or system according to the present invention if a user at position X is not to perceive the side lobe(s) output by the array.

What is claimed is:

1. A method of controlling an acoustic transducer array to generate a directional sound profile, the method including the steps of
(i) controlling the transducer array to generate, on the basis of a first signal, a primary sound profile which, when represented in polar coordinates, has a primary lobe extending along a first axis and an auxiliary lobe, associated with the primary lobe, extending along a second axis which is respectively different to the first axis; and
(ii) generating, on the basis of the first signal, a cancelling signal for controlling the transducer array to generate a cancelling sound profile which, when represented in polar coordinates, has a cancelling lobe extending along said second axis, which cancelling lobe is modified in phase to interfere destructively with said auxiliary lobe.

2. A method according to claim 1,
wherein the amplitude of the auxiliary lobe measurable at a point x on the second axis is frequency dependent.

3. A method according to claim 2,
wherein the step of generating the cancelling signal includes the step of generating the cancelling signal to be capable of controlling the transducer array to generate a cancelling sound profile having a cancelling lobe with a frequency dependent amplitude, measurable at the point x on the second axis, corresponding to the frequency dependent amplitude of the auxiliary lobe measurable at the point x on the second axis.

4. A method according to claim 2,
wherein the step of generating the cancelling signal includes the step of generating the cancelling signal to be capable of controlling the transducer array to generate a cancelling sound profile having cancelling lobe with a frequency dependent amplitude, measurable at the point x on the second axis, matching the frequency dependent amplitude of the auxiliary lobe measurable at the point x on the second axis.

5. A method according to claim 1,
further including the step of providing a beam canceller for generating the cancelling signal on the basis of the first signal.

6. A method according to claim 5,
wherein the beam canceller has a frequency response matching that of the transducer array measured at a point x located on the second axis.

7. A beam canceller for modifying the output of an acoustic transducer array controllable by a controller to generate a primary sound profile which, when represented in polar coordinates, has a primary lobe extending along a first axis and an auxiliary lobe, associated with the primary lobe, extending along a second axis which is respectively different to the first axis, the controller being configured to control the transducer array on the basis of a received first signal; wherein
the beam canceller is configured to provide to the transducer array a cancelling signal, derived from the first signal, suitable for controlling the transducer array to generate a cancelling sound profile which, when represented in polar coordinates, has a cancelling lobe extending along said second axis, but which is modified in phase to interfere destructively with said auxiliary lobe.

8. A beam canceller according to claim 7,
wherein the amplitude of the auxiliary lobe measurable at a point x on the second axis is frequency dependent.

9. A beam canceller according to claim 8,
wherein the beam canceller is configured to provide a cancelling signal for controlling the transducer array to generate a cancelling sound profile having a cancelling lobe with a frequency dependent amplitude, measurable at the point x on the second axis, corresponding to the frequency dependent amplitude of the auxiliary lobe measurable at the point x on the second axis.

10. A beam canceller according to claim 8,
wherein the beam canceller is configured to provide a cancelling signal for controlling the transducer array to generate a cancelling sound profile having a cancelling lobe with a frequency dependent amplitude, measurable at the point x on the second axis, matching the frequency dependent amplitude of the auxiliary lobe measurable at the point x on the second axis.

11. A beam canceller according to claim 8,
wherein the beam canceller has a frequency response matching that of the transducer array measured at a point x located on the second axis.

12. A beam canceller according to claim 8,
further including a filter configured to have a frequency response corresponding to the frequency response of the transducer array measured at a point x located on the second axis.

13. A beam canceller according to claim 8,
further including a filter configured to have a frequency response matching the frequency response of the transducer array measured at a point x located on the second axis.

14. A controller for controlling an acoustic transducer array of one or more transducer elements, the controller including:
control means for controlling the transducer array to generate a primary sound profile which, when represented in polar coordinates, has a primary lobe extending along a first axis and a frequency dependent auxiliary lobe, associated with the primary lobe, extending along a second axis which is respectively different to the first axis; and
a beam canceller according to claim 7.

15. An acoustics apparatus for generating a directional sound profile, the acoustics apparatus including:
an acoustic transducer array having one or more acoustic transducer elements capable of generating acoustic waves;
a controller for controlling the acoustic transducer array to generate a primary sound profile which, when represented in polar coordinates, has a primary lobe extending along a first axis and a frequency dependent auxiliary lobe, associated with the primary lobe, extending along a second axis which is respectively different to the first axis; and
a beam canceller according to claim 7.

16. (canceled)

17. (canceled)

18. (canceled)
